(19) United States
(12) Patent Application Publication
(10) Pub. No.: US 2009/0054816 A1
(43) Pub. Date: Feb. 26, 2009

(54) MASSAGE METHODS

(76) Inventor: Yamuna Zake, New York, NY (US)

Correspondence Address: LADAS & PARRY LLP, 26 WEST 61ST STREET, NEW YORK, NY, 10023, US

(21) Appl. No.: 12/132,214

(22) Filed: Jun. 3, 2008

Related U.S. Application Data
(60) Provisional application No. 60/933,295, filed on Jun. 5, 2007.
(60) Provisional application No. 60/933,298, filed on Jun. 5, 2007.

(51) Int. Cl. A61H 7/00

(52) U.S. Cl. 601/135; 601/134

(57) ABSTRACT

The present invention provides a method of massage wherein a massage practitioner works with a person and a ball. Using the ball enables the massage practitioner to work two areas of the persons body at the same time. The ball also creates leverage that allows easier elongation of muscle and release of bone out of the person's joints.

### CROSS-REFERENCE TO RELATED APPLICATIONS

This application claims the benefit of U.S. Provisional Patent Application No. 60/933,295, filed Jun. 5, 2007, and U.S. Provisional Patent Application No. 60/933,298 filed Jun. 5, 2007, both of which are hereby incorporated by reference in their entirety.

### BACKGROUND OF THE INVENTION

1. Field of the Invention

This invention concerns massage techniques, in particular massage techniques that use a ball to help create traction in muscles.

2. Background Information

In stretching and bodywork, many people have used a ball in improvisational ways. A set of techniques that is instead performed according to specific routines, in a sequence that follows the logic of the neuromuscular system, was described in Body Rolling: An Experiential Approach to Complete Muscle Release, by Yamuna Zake and Stephanie Golden (Healing Arts Press 1997). A person can use such techniques on himself or herself to help create traction in various muscles. A concept used generally in Body Rolling techniques is that muscles release from origin to insertion. Following this concept, a person places a ball at a point on his or her body where a muscle begins: where its tendon touches bone. The person then releases his or her body weight toward the ground via the ball; the pressure from the ball stimulates the tendon, bringing increased circulation to the area.

These known techniques can be used for a variety of treatments, from treating specific conditions such as sciatica to allowing a person to unwind after a vigorous workout. But they are limited because they involve a person working alone, using the ball for self therapy. It would be useful to have techniques in which a person can work with a massage practitioner who can combine hands on and ball techniques for more effective treatments.

### BRIEF DESCRIPTION OF THE DRAWINGS

FIG. 1 depicts a massage practitioner working with a person according to one aspect of the present invention.

FIG. 2 depicts a massage practitioner working with a person according to another aspect of the present invention.

FIG. 3 depicts a massage practitioner working with a person according to yet another aspect of the present invention.

FIG. 4 depicts a massage practitioner working with a person according to yet another aspect of the present invention.

FIG. 5 depicts a massage practitioner working with a person according to yet another aspect of the present invention.

FIG. 6 depicts a massage practitioner working with a person according to yet another aspect of the present invention.

FIG. 7 depicts a massage practitioner working with a person according to yet another aspect of the present invention.

### DETAILED DESCRIPTION OF THE PREFERRED EMBODIMENTS

In a method according to the present invention, a massage practitioner uses the hands together with a special ball. Preferably, a treatment using methods according to the invention lasts about one hour.

The overall goal of the treatment is to prevent injury and relieve pain and discomfort. The specific effects of the treatment are to elongate muscle; break up adhesions and scar tissue; mobilize joints; release muscle tightness and tension; increase muscle and joint function, tone, and mobility; increase circulation; and improve alignment. In addition, direct bone stimulation improves bone quality and stimulates tendon bone attachments, increasing circulation into muscle origins, which enhances muscle performance.

Using the ball enables the practitioner to work two areas of the body at the same time. The ball also creates leverage that allows easier elongation of muscle and release of bone out of joints.

The special ball is preferably reinflatable and made from PVC plastic. A number of balls having a variety of sizes and densities may be used for persons of various heights and weights and for various body parts to be worked. Preferably, ball diameters range from 4″ to 11″, with densities that enables them to hold up to 350 pounds of pressure.

In a preferred embodiment, the practitioner chooses a specific ball according to the person's body type and the part of body being worked (thus different balls may be used during a single massage session).

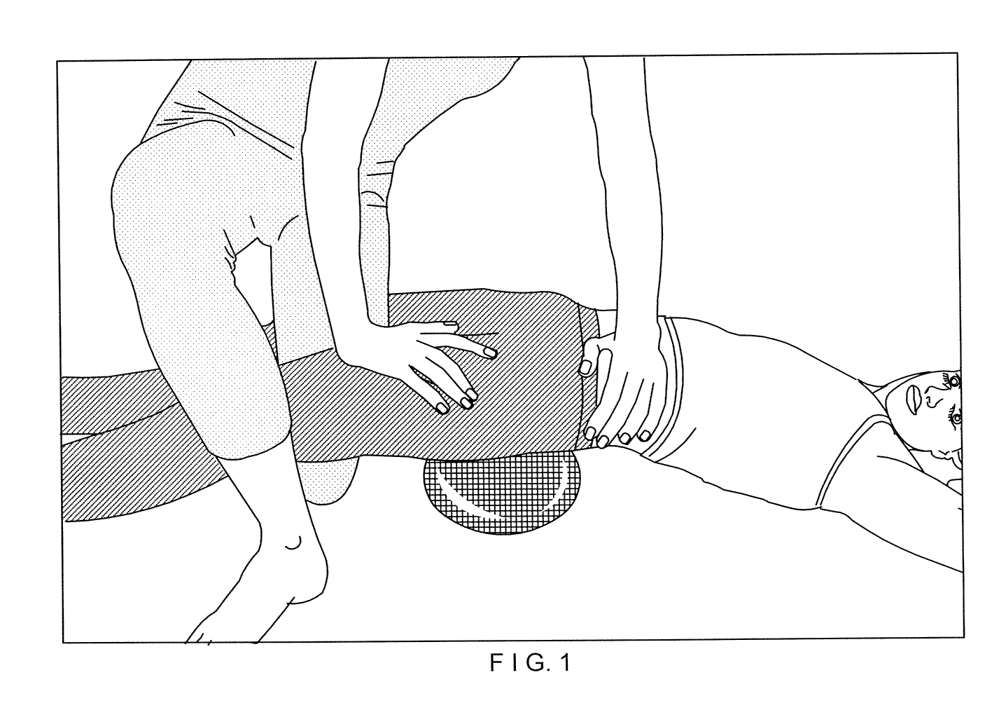

As shown in the example of FIG. 1, with the person lying face up, the practitioner places the ball at the highest point on one thigh, where the femur articulates with the pelvis. The person's leg rests over the ball, and the practitioner uses the weight of the leg to traction the leg out from the joint and down and around the ball. The ball acts as a fulcrum, providing extra leverage that increases intraarticular space and range of motion.

Preferably, the method continues as follows:

The practitioner continues moving the ball down the thigh toward the knee, repeating the action of tractioning the leg out from the hip and down and around the ball every 2 or 3 inches. At each point, the traction is held for 10-15 seconds to give time for the muscles to elongate and realign themselves.

When the ball is under the knee, with the leg weight bearing down into the ball, the practitioner places one hand above the knee and one hand below it and applies traction away from the knee in both directions, holding for 10-15 seconds.

The practitioner continues working the ball down the calf in the same way, with one hand stabilizing the leg into the ball and the other hand tractioning the leg down and around the ball.

Next the practitioner places the ball directly under the ankle, with one hand stabilizing the ankle by pressing the front of it down into the ball, and the other hand tractioning the foot into extension down and around the ball.

The practitioner then takes the ball from under the ankle and repeats this procedure on the other leg, starting again at the hip where the femur articulates with the pelvis, as described above.

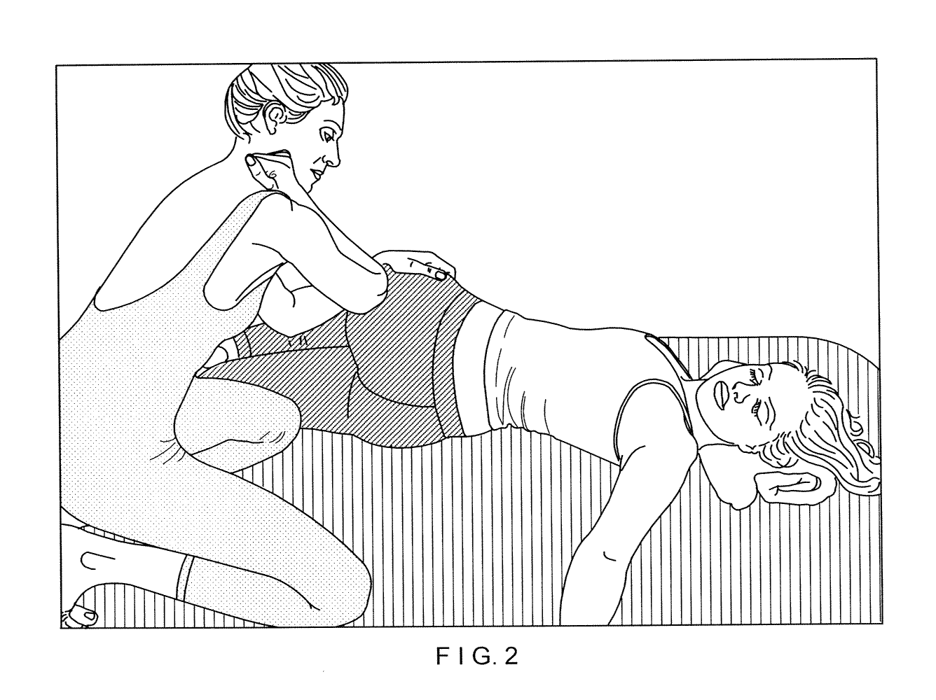

Next, as shown in FIG. 2, the practitioner returns to the first leg that was worked. The knee is bent up and crossed over the body, so this side of the pelvis lifts off the floor. The ball is placed under the buttock of this side, in line with the side of the sacrum, with the practitioner straightening out the leg and using one hand to traction the leg out from the hip. The other hand preferably applies traction to the muscles above the iliac crest, pressing them down and around the ball toward the floor.

Preferably, the method continues as follows:

The practitioner moves the ball downward to the hip joint. The person's knee is bent up, then directly out to the side, and the ball is placed against the side of the hip joint. The practitioner uses both hands to apply direct pressure to the inner thigh and down into the ball. The practitioner then removes the ball, and the person's hip comes down to the floor. Keeping the knee bent out to the side at hip level, the practitioner places the ball on the floor under the side of the hip joint and presses the leg down over the ball; the practitioner continues working out to the knee, pressing the inner thigh down into the ball. (This action also affects the outside of the thigh.)

This work on the pelvis and thigh is then repeated on the other side.

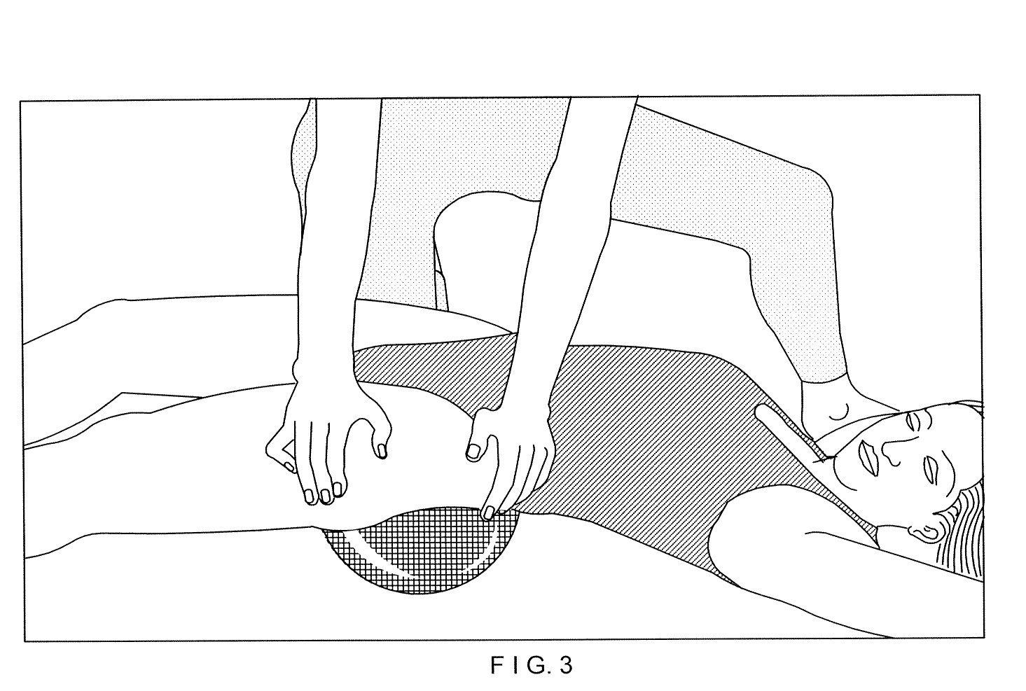

Next, as shown in FIG. 3, the practitioner places the ball under the sacrum on the first side of the body and uses both hands to apply direct pressure into the hip bones, pressing straight down into the floor. The practitioner then preferably moves the person's body slightly to the other side so that the ball rolls into the sacroiliac joint on the side being worked, using both hands to apply pressure down into the front of the hip bone on that side. (This action releases the sacroiliac joint.)

Preferably, the method continues as follows:

The person is moved slightly downward, so that the ball rolls into the lower back. and both buttocks come to the floor. With one hand, the practitioner presses the side of the person's abdomen down into the ball, pressing the abdominal muscles toward the spine while also pushing these muscles upward toward the rib cage; the practitioner's other hand presses the hip bone on that side down toward the floor.

In this example, the person is now leaning back into the ball, using one hand to support the head. With one hand, the practitioner supports the person's body from the back, just above the ball. As the one hand, is moved upward point by point, one of the practitioner's hands tractions the spine upward, while the other hand tractions the abdomen, then the ribs, up and around the ball. (The action is to push the abdomen back against the ball and then to lift the ribs, applying traction around the ball to expand the rib cage, deepen the breathing, and elongate this entire side of the body.) When the ball is halfway up the ribs, the practitioner tractions the person's arm on the side being worked overhead with one hand and supports the person's head with the other hand.

When the ball reaches shoulder level, the practitioner moves the person's arm downward so that it extends outward at shoulder level. As one of the practitioner's hands continues to support the head, the other hand is at the top of the chest, pulling the pectoral muscle out to the side and molding the arm and shoulder down and around the ball.

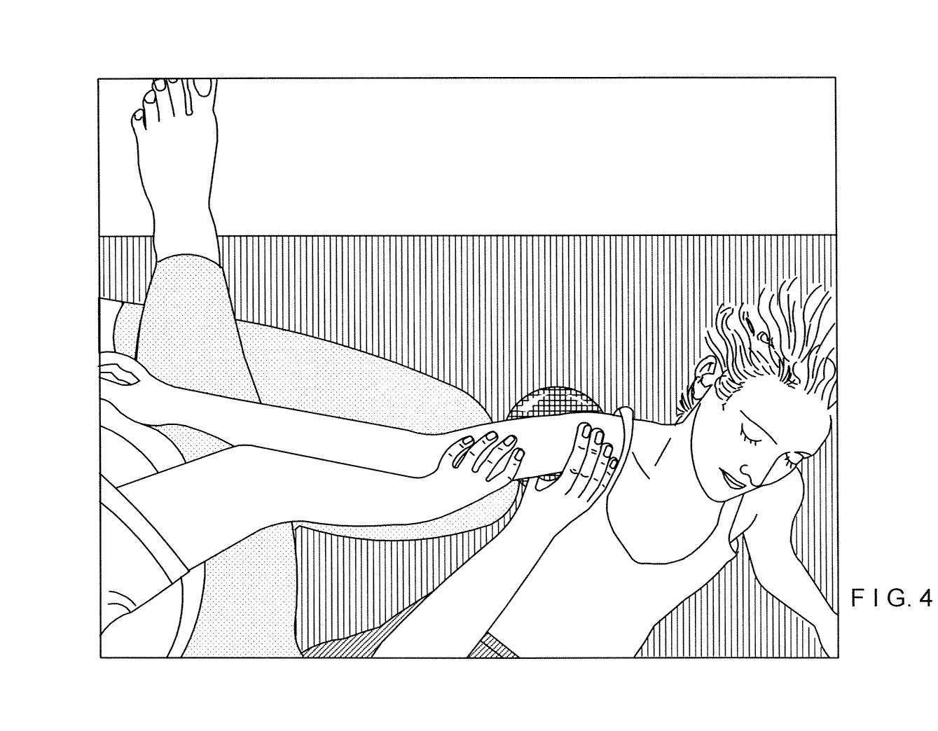

Next, as shown in FIG. 4, the practitioner uses one hand to stabilize the shoulder joint while tractioning the arm out from the shoulder with the other hand. The ball is beneath the triceps, and the practitioner's hand presses into the biceps. The practitioner preferably works point by point out to the elbow, then moves the ball below the elbow to the top of the ulna and works down the ulna to the little finger.

Preferably, the method continues as follows:

The practitioner brings the ball to the bottom of the back of the neck. The person's upper back and shoulders are now on the floor, with the ball supporting the neck. The practitioner tractions the shoulder toward the feet and the head in the opposite direction.

This work, starting with the knee being crossed over the body, is then repeated on the other side of the back.

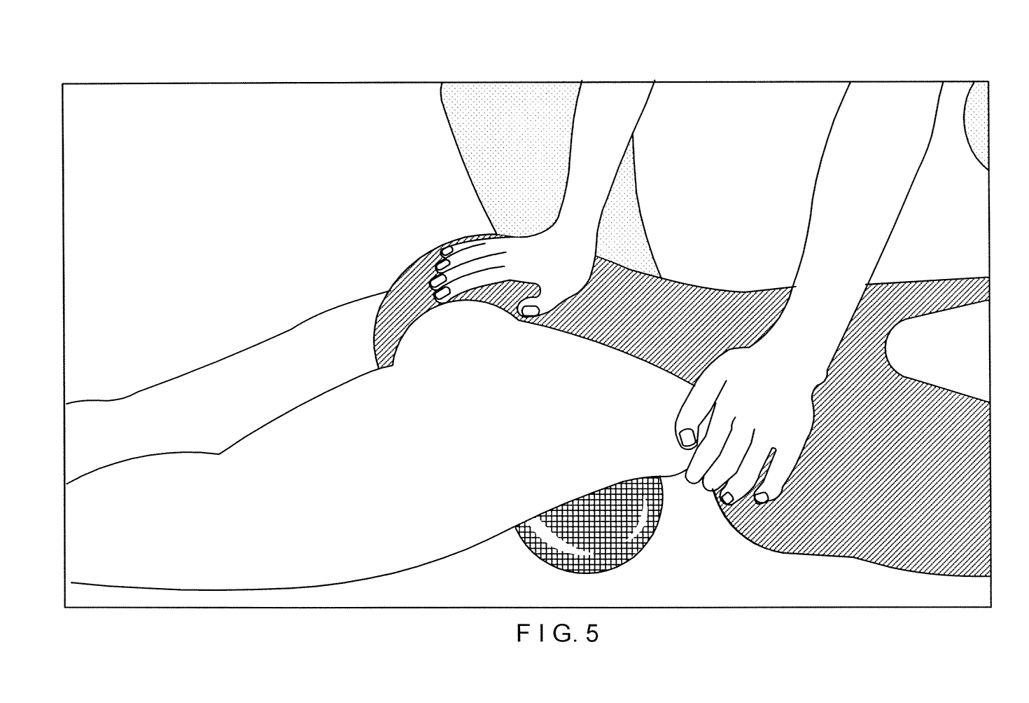

Next, as shown in FIG. 5, the practitioner turns the person over to lie face down.

The ball is placed at the top of one thigh, at the groin, with the practitioner tractioning the leg out and down around the ball. Preferably, the practitioner works point by point down the thigh until the ball is just above the knee.

Preferably, the method continues as follows:

The ball is moved to just below the top of the tibia. The practitioner uses one hand to support the patella from underneath, while the other hand presses the leg down into the ball. The practitioner continues to work down the leg in 1 to 2 inch increments with one hand pressing the tibia down into the ball while the other hand tractions the leg out and down applying pressure precisely at the most distal edge of the ball, working as far as the front of the ankle. At this point, one hand stabilizes the ankle down into the ball, while the other hand tractions the back of the heel out and away from the ankle.

The practitioner then works down the dorsal side of the foot; at each point, one hand tractions the heel away from the leg, while the other hand presses down into the plantar foot, all the way to the tips of the toes.

This work on the front of the leg is then repeated on the other side.

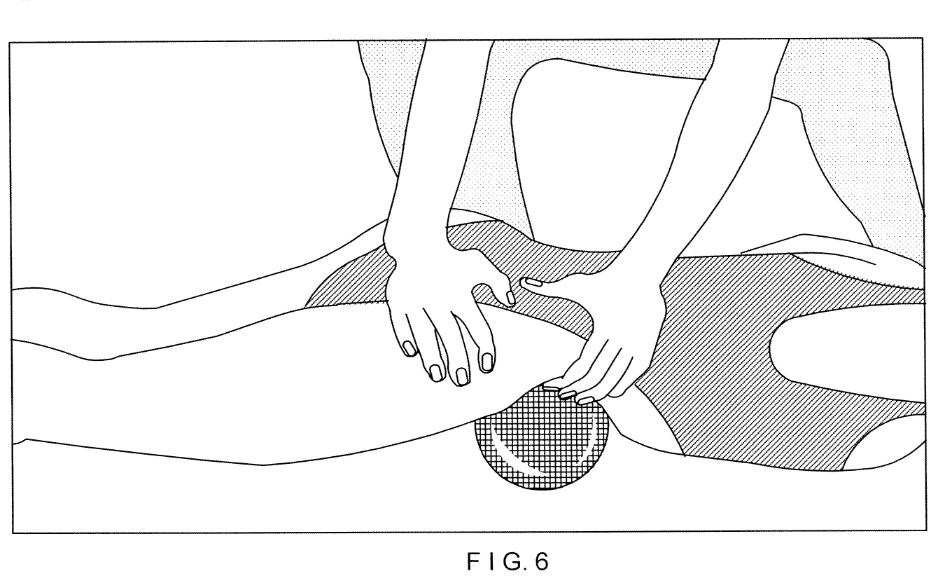

Next, as shown in FIG. 6, the practitioner places the ball under the center of the person's pubic bone and gently applies direct pressure into the sacrum with both hands. The ball is then preferably moved just above the pubic bone. Preferably, with one hand, the practitioner presses the sacrum down and around the ball; the other hand is placed just above the sacrum, pressing the lumbar spine upward to elongate the back.

Preferably, the method continues as follows:

The practitioner moves the ball into one side of the abdomen; one hand is at the side of the pelvic bone, holding it stationary, while the other hand is at the sacroiliac joint, working to fold that side of the pelvis around the ball. The practitioner moves the ball up that side of the abdomen in small increments, one hand tractioning the buttock down and the other hand at the front of the body, pulling the abdominal muscles toward the rib cage. The person's arm is extended overhead. When the ball reaches the level of the navel, the practitioner's hand works to pull the rib cage toward the head.

After working at navel level, the practitioner moves the ball to a point 2 inches above the bottom of the sternum on that same side of the body; the person's arm is still extended overhead. Synchronizing with the rhythm of the person's inhalations and exhalations, the practitioner uses both hands to exert gentle downward pressure, spreading the rib cage out around the ball.

For women, when the ball is above breast tissue and still below the clavicle, the practitioner moves the person's arm so it extends outward at shoulder level. The practitioner then moves the ball in small increments out along the bottom of the clavicle to the shoulder. The practitioner's hands are on the person's back, working to spread the small muscles of the spine out toward the shoulder by applying gentle pressure out to the side and around the ball.

When the ball reaches the shoulder, the practitioner places it at the front of the shoulder joint. The practitioner uses both hands at the back of the joint, applying direct pressure down into the ball to release the joint.

Next, the practitioner moves the ball in 1 to 2 inch increments out along the inner side of the arm toward the elbow. One hand stabilizes the shoulder joint, while the other hand tractions the humerus out from the joint and down and around the ball. The ball is beneath the triceps, and the practitioner applies pressure directly onto the biceps, working to a point just above the elbow.

Now the practitioner moves the ball to just below the elbow, turns the arm so that the thumb faces up, and works in the same way down the radius to the thumb.

This work, starting from the pubic bone, is then repeated on the other side of the body.

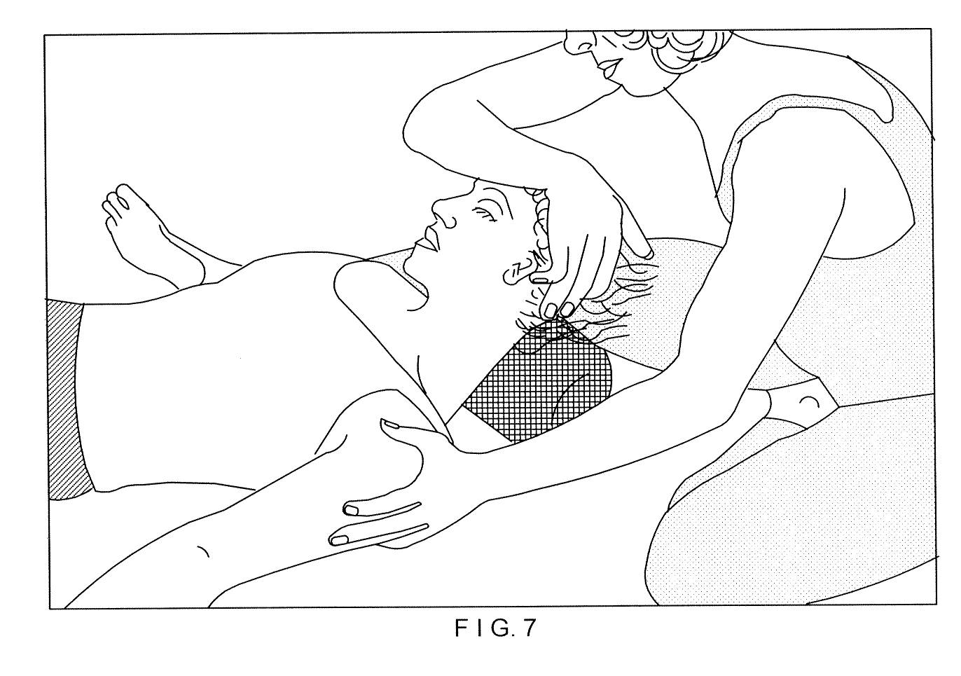

Next, as shown in FIG. 7, the practitioner turns the person over to lie on the back and places the ball under the back of the neck. The practitioner then gently tractions each side of the neck in turn, preferably with one, hand pushing down on the shoulder and the other hand pulling up on the occiput. Preferably, the last action is to place one palm on the frontal bone in the center of the forehead and apply gentle pressure to the head, pushing it against the ball; the other hand is at the top of the sternum, applying gentle downward pressure, away from the neck.

In another embodiment of the invention there is provided a method of massage in which a massage practitioner again works with a person and a ball. The method typically lasts approximately one hour if the person is massaged initially lying face down and then subsequently lying face up. Alternatively the method may last approximately 30 minutes when the person is massaged lying face up only.

The overall goal of the method is to increase flexibility by breaking up habitual misalignment patterns in the body. The specific effects of the method are to increase circulation and range of motion, to relax tissue, and to free muscle restrictions. In addition, the method equalizes muscle length between the two sides of the body. Since in many people there is asymmetry between the sides, the result is to improve posture and alignment, thus improving mobility and decreasing discomfort caused by the asymmetry.

The method preferably uses a reinflatable ball typically made from PVC plastic. The ball usually has a density that enables it to hold up to 350 pounds of pressure and it is preferably 8″ to 12″ in diameter. The practitioner selects a ball dependent upon a person's size. Using the ball enables the practitioner to work both the back and the front of the person's body at the same time.

Generally the ball is placed under the body part being worked, and the practitioner rolls that body part around the ball, upward and downward (that is, toward the head, then toward the feet), side to side, and in circular movements, both clockwise and counter-clockwise. The side-to-side movements have the effect of cross-fibering tissue; the up and down movements traction the body, creating length; and the circular movements knead the tissue.

Wherein the method typically lasts approximately one hour the methods begins with the person lying face down. The practitioner places the ball at the top of one thigh, at the point where the femur articulates with the pelvis and positioned at the person's side, the practitioner tractions the person's leg down and around the ball. Then, holding the leg with both hands, the practitioner rolls the leg upward and downward, side to side, and in circular movements clockwise, then counterclockwise over the ball. Consequently the person's entire body is being moved and rocked.

The practitioner continues to move the ball down the thigh in 2-inch increments, repeating these rolling and rocking movements at each point, up to about 2 inches above the knee. The ball is not, however rolled over the knee. The practitioner then moves the ball below the person's knee, so that the shin rests on the ball. The practitioner rolls the shin over the ball, using upward and downward, side-to-side, and circular movements. The practitioner works in this way down to the ankle, in 2-inch increments.

The practitioner then bends the person's knee out to the side, places the ball at the groin, and tractions the leg out from the hip. The practitioner then repeats the same movements-rocking upward and downward side to side, and circularly-working in 2-inch increments down to the knee. The inner calf is then worked in the same manner until the ball reaches the ankle. At the ankle, the foot is turned in, then out, and each side of the ankle is worked around the ball, using the upward and downward, side-to-side, and circular movements.

The practitioner then takes the ball from under the leg and repeats this work on the other leg starting from the top of the thigh.

The practitioner then places the ball under the person's pubic bone. The practitioner places the hands on the sacrum and gently rocks the pelvis around the ball. The practitioner uses all the above mentioned rocking movements, but here they are done very gently, using light pressure.

Subsequently the person then instructed to position their arms up above their head. The practitioner moves the ball to just above the pubic bone, places one hand on each side of the pelvis, and rocks the pelvis side to side, then in circular movements. Only these two movements are used in the abdomen.

The ball is then positioned 2 inches above the bottom of the sternum, with the persons' arms still positioned above their head. The practitioner instructs the person to breathe into the ball One of the practitioner's hands gently tractions the arm on one side above the head. The practitioner's other hand is placed at the side of the spine and pushes upward to help the arm stretch above the head. At this point the practitioner rocks the person over the ball from side to side, then in circular movements in both directions. Both of the practitioner's hands rock the body around the ball, with the hand holding the person's arm using that arm to help move the body.

Wherein the person is male the practitioner can roll the ball out from the sternum across the chest on the side being worked as the body is rocked. However if the person is a female the rocking movements are much smaller, to protect breast tissue, so the ball rolls only slightly off the sternum. The objective of this is to mold one side of the rib cage gently around the ball, spreading that side out laterally.

The practitioner then moves the ball up the person's sternum in 2-inch increments, repeating the rocking movements at each point, Once the ball has reached the collarbone, the practitioner moves the arm being tractioned out to the side at shoulder level, and instructs the person to turn the head in the opposite direction. The practitioner then begins to roll the ball out just below the collarbone toward the shoulder in 2-inch increments. One of the practitioner's hands is positioned on the person's upper back at shoulder level and the other hand holds the top of the shoulder and the top of the arm and tractions the arm out, then pushes it slightly in, then out again, working to pull the rib cage and shoulder blade away from the spine. The practitioner then moves the arm upward and downward and then moves the shoulder in large circles in both directions. This is repeated at each point until the ball reaches the shoulder joint.

The practitioner continues rolling the ball down the arm to the elbow in 2-inch increments, repeating the same movements at each point (in and out, up and down, and in circles). The practitioner works down to the wrist, this time turning the arm first in one direction, then in the other, continuing the in-and-out and up-and-down movements. The practitioner repeats this work on the other arm, starting with the ball at the point where the sternum articulates with the collarbone.

Subsequently the practitioner turns the client over to lie on their back. The following describes both the completion of the method that lasts approximately 1 hour and the method that lasts approximately 30 minutes if the following is conducted in isolation.

The practitioner places the ball under the hamstrings of one leg, just below the sitbone. The leg is tractioned out from the hip, then moved upward and downward, side to side, and in circular movements as mentioned herein above. The practitioner works down the leg in 2-inch increments until the ball is 2 inches above the knee.

The practitioner then places the ball under the knee, tractions the leg from below the knee, then uses one hand placed above the knee and one below the knee to apply traction in both directions. This traction is held for approximately 30 seconds. The practitioner then rolls the knee gently from side to side around the ball, and then in easy circles in both directions.

The practitioner then continues working down the calf in 2-inch increments in this way until the ball reaches the ankle. This work is then repeat on the other leg, starting with the ball under the hamstrings. The practitioner then bends one of the person's knees upwards and crosses that knee over the other side of the body. The ball is then placed underneath the hip joint and bends the knee out to the side, so that the ball is at the hip joint. The practitioner rocks the hip around the ball, so that the ball rolls along the crease of the hip joint. Rocking the leg and hip around the ball in this position releases the entire hip joint.

The practitioner then brings the knee back to center, takes the ball away, and brings the hip back to the floor. The ball is placed on the floor just at the outside of the hip, and the knee is lowered back down so that the outside of the thigh lies over the ball. The practitioner tractions the leg out from the hip, then rocks the leg from side to side, then in big circles in both directions. This is continued in 2-inch increments to the knee, then down to the ankle. The sequence is then repeated on the other leg, starting with bending the other knee toward the ceiling.

The practitioner then places the ball under the person's sacrum. The practitioner stands over the person, with one leg on either side of the person's body. Placing one hand on each of the person's hips, the practitioner rocks the pelvis from side to side and this is the only rocking movement used at this point. The practitioner then moves the ball to one side, so it is under the gluteus maximus muscle, and rocks the pelvis side to side, then in circular movements in both directions on one side only. The ball is then moved under the gluteus maximus muscle on the other side and the rocking movements are repeated.

The practitioner then moves the ball to the lower back, just above the pelvic bone, on one side of the lumbar spine. One of the practitioner's hands holds the abdomen on that side. The other hand holds the person's back at a point just above the ball. The practitioner rocks the person's body upward and downward, side to side, and circularly, staying on that side of the spine. During rocking, the back hand also tractions slightly upward, supporting the back.

The person, who at this point is leaning back against the ball, is instructed to raise the arm on the side being worked above the head. The practitioner begins to move the ball up the rib cage in 2-inch increments. At each point, one of the practitioner's hands rocks the rib cage around the ball, up and down, and side to side, while the other hand lifts the person's shoulder to increase length in that side. The practitioner works in this way up to the level of the collarbone. At this point, one of the practitioner's hands supports the person's head and neck, while the other hand is on the person's shoulder and upper chest, working to stretch the upper rib cage out and around the ball, wrapping the shoulder around the ball toward the floor.

The practitioner then begins to move the ball out to the shoulder joint in 2-inch increments. One hand continues to support the person's head. The other hand continues the movements of wrapping the shoulder down and around the ball. This is then repeated on the other side, starting with the ball at the bottom of the lumbar spine on the other side.

The practitioner then places the ball under the back of the person's neck on one side. With one hand, the practitioner tractions the shoulder on that side downward. The other hand is placed on the occipital ridge and gently lifts upward on that side of the head. The practitioner gently rocks the head and shoulder from side to side, maintaining gentle traction to increase the length of the neck. The practitioner then repeats this on the other side, placing the ball on the other side of the back of the neck.

After the method lasting approximately 1 hour the person feels a greater amount of depth and space from the front to the back of the body. The feeling is that the rib cage is taking up more space. The breath capacity increases, the body feels more energized and every part of the body feels opened and released beyond the range of motion it had before. Furthermore the person experiences generally a great sense of release and freedom. After the method lasting approximately 30 minutes the results are similar, however the sense of release is less pronounced.

The methods of the present invention differs greatly from other body therapies that employ a ball. These systems use balls for stretching and for creating stability. However the present invention uses the ball for actual hands-on treatment and enables the practitioner to work both sides of the body at the same time.

Two features in particular differentiate the present invention from other body therapies, First, the placement of the ball under the body part being worked means that both sides of the body are affected at the same time. Secondly, rocking a part of the body around the ball works that part in all possible directions, creating a sense of three-dimensional space and a full front-to-back release that other body therapies do not provide. Other forms of massage are linear; they do not give the sensation that both sides are being worked at once or the experience of increased depth and of feeling space in the body from the inside out.

1. A method of massage in which a massage practitioner works with a person and a ball, comprising:
(a) first, with the person lying down, the practitioner places the ball on one of the person's thighs where the femur articulates with the pelvis, with the leg associated with that thigh resting over the ball, and the practitioner uses the weight of the leg to traction the leg out from the joint and down and around the ball;
(b) second, the practitioner places the ball under one of the person's buttocks in line with the side of the sacrum, with the knee on that side of the person's body bent and crossed over the body so as to lift the pelvis, and the practitioner straightens out the leg associated with the knee on that side of the body, using one hand to traction the leg out from the hip;
(c) third, the practitioner places the ball under the sacrum on one side of the person's body, and the practitioner uses both hands to apply pressure into the hip bones;
(d) fourth, the practitioner places the ball beneath the triceps on one side of the person's body, and the practitioner tractions the arm out from the shoulder with the one hand while using the other hand to stabilize the shoulder;
(e) fifth, with the person lying face down, the practitioner places the ball at the top of one of the person's thighs at the groin, and the practitioner tractions the leg out and down around the ball;
(f) sixth, the practitioner places the ball under the center of the person's pubic bone, and the practitioner applies pressure into the sacrum with both hands; and
(g) seventh, with the person lying face up, the practitioner places the ball under the back of the neck and the practitioner tractions each side of the neck in turn.

2. A method of massage in which a massage practitioner works with a person and a ball, comprising:
(a) first, with the person lying down, the practitioner places the ball on one of the person's thighs, with the leg associated with that thigh resting over the ball, and the practitioner uses the weight of the leg and the ball to traction the leg;
(b) second, the practitioner places the ball under one of the person's buttocks, with the knee on that side of the person's body bent and crossed over the body so as to lift the pelvis, and the practitioner straightens out the leg associated with the knee on that side of the body;
(c) third, the practitioner places the ball under the sacrum on one side of the person's body, and the practitioner applies pressure into the hip bones;
(d) fourth, the practitioner places the ball beneath the triceps on one side of the person's body, and the practitioner tractions the arm out from the shoulder;
(e) fifth, with the person lying face down, the practitioner places the ball at the top of one of the person's thighs, and the practitioner uses the ball to traction the leg;
(f) sixth, the practitioner places the ball under the person's pubic bone, and the practitioner applies pressure into the sacrum; and
(g) seventh, with the person lying face up, the practitioner places the ball under the back of the neck and the practitioner tractions at least one side of the neck.

3. A method according to claim 1 wherein the first step further comprises the steps of:
(a) the practitioner continues moving the ball down the thigh toward the knee, repeating the action of tractioning the leg out from the hip and down and around the ball every 2 or 3 inches, holding the traction at each point for 10-15 seconds to give time for the muscles to elongate and realign themselves;
(b) when the ball is under the knee, with the leg weight bearing down into the ball, the practitioner places one hand above the knee and one hand below it and applies traction away from the knee in both directions, holding for 10-15 seconds;
(c) the practitioner continues working the ball down the calf, with one hand stabilizing the leg into the ball and the other hand tractioning the leg down and around the ball;
(d) the practitioner places the ball directly under the ankle, with one hand stabilizing the ankle by pressing the front of it down into the ball, and the other hand tractioning the foot into extension down and around the ball; and
(e) the practitioner takes the ball from under the ankle and repeats the first step on the other leg.

4. A method according to claim 1 wherein the second step further comprises the steps of:
(a) while the practitioner is using one hand to traction the leg out from the hip, the practitioner uses the other hand to traction the muscles above the iliac crest, pressing them down and around the ball;
(b) with the person's knee bent up and directly out to the side, the practitioner places the ball placed against the side of the hip joint, and the practitioner uses both hands to apply direct pressure to the inner thigh and down into the ball;
(c) the practitioner places the ball under the side of the hip joint, and the practitioner presses the leg down over the ball;
(d) the practitioner continues working out to the knee, pressing the inner thigh down into the ball; and
(e) the practitioner repeats the second step on the other side of the body.

5. A method according to claim 1 wherein the third step further comprises the steps of:
(a) the practitioner moves the person's body so that the ball rolls into the sacroiliac joint on the side being worked, using both hands to apply pressure down into the front of the hip bone on that side;
(b) the practitioner moves the person's body so that the ball rolls into the lower back, and the practitioner uses one hand to press the side of the person's abdomen down into the ball, pressing the abdominal muscles toward the spine while also pushing these muscles upward toward the rib cage, and the practitioner uses the other hand to press the hip bone on that side of the body down;
(c) with the person leaning back into the ball, the practitioner uses one hand to support the person's body from the back, just above the ball; the practitioner moves the ball upward point by point, with one of the practitioner's hands tractioning the spine upward while the practitioner's other hand tractioning the abdomen, and then the ribs, up and around the ball;
(d) when the ball is halfway up the ribs, the practitioner fractions the person's arm on the side being worked overhead with one hand and supports the person's head with the practitioner's other hand; and
(e) when the ball reaches shoulder level, the practitioner moves the person's arm downward so that it extends outward at shoulder level, with one of the practitioner's hands supporting the person's head and the practitioner's other hand at the top of the chest, pulling the pectoral muscle out to the side and molding the arm and shoulder down and around the ball.

6. A method according to claim 1 wherein the fourth step further comprises the steps of:
(a) while the practitioner tractions the arm out from the shoulder, the practitioner works point by point out to the elbow, then moves the ball below the elbow to the top of the ulna and works down the ulna to the little finger;
(b) the practitioner moves the ball to the bottom of the back of the neck so that the ball supports the neck, and the practitioner tractions the shoulder toward the person's feet and the person's head in the opposite direction; and
(c) the practitioner repeats the fourth step on the other side of the person's body.

7. A method according to claim 1 wherein the fifth step further comprises the steps of
(a) while the practitioner tractions the leg out and down around the ball, the practitioner works point by point down the thigh until the ball is just above the knee;
(b) the practitioner moves the ball to just below the top of the tibia, and the practitioner uses one hand to support the patella from underneath, while the practitioner's other hand presses the leg down into the ball, and the practitioner works down the leg in 1 to 2 inch increments with one hand pressing the tibia down into the ball while the other hand tractions the leg out and down applying pressure precisely at the most distal edge of the ball, working as far as the front of the ankle, at which point one hand stabilizes the ankle down into the ball, while the other hand tractions the back of the heel out and away from the ankle;
(c) the practitioner then works down the dorsal side of the foot, at each point one hand tractions the heel away from the leg, while the other hand presses down into the plantar foot, all the way to the tips of the toes; and
(d) the practitioner repeats the fifth step on the other side of the body.

8. A method according to claim 1 wherein the sixth step further comprises the steps of:
(a) the practitioner moves the ball just above the pubic bone, and the practitioner, with one hand, presses the sacrum down and around the ball, while the other hand is placed just above the sacrum, pressing the lumbar spine upward to elongate the back;
(b) the practitioner moves the ball into one side of the abdomen, using one hand at the side of the pelvic bone to hold it stationary, while using the other hand at the sacroiliac joint to fold that side of the pelvis around the ball;
(c) the practitioner moves the ball up that side of the abdomen in small increments, one hand tractioning the buttock down and the other hand at the front of the body, pulling the abdominal muscles toward the rib cage, with the person's arm extended overhead;
(d) when the ball reaches the level of the navel, the practitioner's hand works to pull the rib cage toward the head;
(e) the practitioner moves the ball to a point about 2 inches above the bottom of the sternum on that same side of the body, with the person's arm is still extended overhead, and the practitioner, synchronizing with the rhythm of the person's inhalations and exhalations, uses both hands to exert downward pressure, spreading the rib cage out around the ball;
(f) if the person is a woman, when the ball is above breast tissue and still below the clavicle, the practitioner moves the person's arm so it extends outward at shoulder level, then the practitioner moves the ball in small increments out along the bottom of the clavicle to the shoulder, with the practitioner's hands on the person's back, working to spread the small muscles of the spine out toward the shoulder by applying pressure out to the side and around the ball;
(g) when the ball reaches the shoulder, the practitioner places the ball at the front of the shoulder joint, and the practitioner uses both hands at the back of the joint to apply direct pressure down into the ball to release the joint;
(h) the practitioner moves the ball in 1 to 2 inch increments out along the inner side of the arm toward the elbow, with one hand stabilizing the shoulder joint, while the other hand tractions the humerus out from the joint and down and around the ball;
(i) when the ball is beneath the triceps, the practitioner applies pressure directly onto the biceps, working to a point just above the elbow;
(j) the practitioner moves the ball to just below the elbow, turns the arm so that the thumb faces up, and works in the same way down the radius to the thumb; and
(k) the practitioner repeats the sixth step on the other side of the body.

9. A method according to claim 1 wherein the seventh step further comprises the steps of:
(a) while the practitioner tractions each side of the neck, one hand pushes down on the shoulder and the other hand pulls up on the occiput; and
(b) the practitioner places one palm on the frontal bone in the center of the forehead and applies pressure to the head, pushing it against the ball, and the practitioner places the other hand at the top of the sternum, applying downward pressure, away from the neck.

10. A method of massage in which a massage practitioner works with a person and a ball comprising the steps of
(a) the practitioner placing the ball under one of the person's hamstrings just below the sitbone with the person lying face up, tractioning the leg out from the hip, rolling the leg around the ball, in an upward and downward movement, in a side to side movement and in a clockwise and counterclockwise circular movement and repeating the movements down the leg at approximately 2-inch increments until the ball is positioned approximately 2 inches above the knee;
(b) the practitioner placing the ball under the knee, tractioning the leg from below the knee, placing one hand above the knee and one hand below the knee and applying traction in both directions for approximately 30 seconds and then rolling the knee from side to side around the ball and subsequently rolling the knee around the ball in small clockwise and counterclockwise circular movements and repeating the movements down the calf at approximately 2-inch increments until the ball is positioned at the ankle;
(c) the practitioner repeating steps (a) and (b) on the person's other leg;
(d) the practitioner bending one of the person's knees upwards and crossing that knee over the other side of the person's body, placing the ball underneath the hip and bending the knee out to the side so that the ball is at the hip joint and rolling the hip around the ball such that the ball rolls along the crease of the hip joint,
(e) the practitioner bringing the knee back from across the body, removing the ball and positioning the hip back downwards, placing the ball just at the outside of the hip, lowering the knee downwards so that the outside of the thigh lies over the ball, tractioning the leg out from the hip, rolling the leg from side to side around the ball and subsequently rolling the leg around in large clockwise and counterclockwise circular movements and repeating the movements down at approximately 2-inch increments until the ball is positioned at the ankle;
(f) the practitioner repeating steps (d) and (e) on the person's other leg;
(g) the practitioner placing the ball under the person's sacrum, standing over the person, with one leg on either side of the person's body and with one hand placed on each of the person's hips, rolling the pelvis around the ball from side to side, moving the ball to one side so that it is under the gluteus maximus muscle, rolling the pelvis from side to side around the ball and subsequently rolling the pelvis around in clockwise and counterclockwise circular movements, moving the ball to the other side so that it is under the gluteus maximus muscle, rolling the pelvis from side to side around the ball and subsequently rolling the pelvis around in clockwise and counterclockwise circular movements;
(h) the practitioner moving the ball to the person's lower back, just above the pelvic bone, on one side of the lumbar spine, holding the abdomen on that side with one hand whilst holding the person's back at a point just above the ball and tractioning slightly upward with the other hand, rolling the person's body around the ball in an upward and downward movement, in a side to side movement and in a clockwise and counterclockwise circular movement;
(i) the person raising the arm associated with the side of the body upon which step (h) was conducted above their head, the practitioner moving the ball up the rib cage and with one hand rolling the rib cage around the ball in an upward and downward movement and in a side to side movement whilst lifting the person's shoulder with the other hand and repeating the movements at approximately 2-inch increments until the ball is positioned at the level of the collarbone;
(j) the practitioner supporting the person's head and neck with one hand whilst the other hand is positioned on the person's shoulder and upper chest, stretching the person's upper rib Cage out and around the ball, wrapping the shoulder down and around the ball, moving the ball out to towards the shoulder joint and repeating wrapping the shoulder down and around the ball at approximately 2-inch increments;
(k) the practitioner repeating steps (h), (i) and (j) on the person's other side;
(l) the practitioner placing the ball under the back of the person's neck on one side, tractioning the shoulder on that side downward with one hand, placing the other hand on the person's occipital ridge and lifting upward on that side of the head, rolling the person's head and shoulder from side to side around the ball whilst maintaining traction to increase the length of the neck;
(m) the practitioner repeating step (l) on the person's other side.

11. A method of massage in which a massage practitioner works with a person and a ball comprising the steps of
(a) the practitioner placing the ball at the top of a person's thigh at the point where the femur articulates with the pelvis with the person lying face down, tractioning the person's leg down and around the ball, rolling the leg around the ball in an upward and downward movement, in a side to side movement and in a clockwise and counterclockwise circular movement and repeating the movements down the leg at approximately 2-inch increments until the ball is positioned approximately 2 inches above the knee;
(b) the practitioner placing the ball below the person's knee so that the person's shin rests on the ball, rolling the shin around the ball in an upward and downward movement, in a side to side movement and in a clockwise and counterclockwise circular movement and repeating the movements down the shin at approximately 2-inch increments until the ball is positioned at the ankle;
(c) the practitioner bending the person's knee out to the side and placing the ball at the person's groin, tractioning the leg out from the hip, rolling the leg around the ball in an upward and downward movement, in a side to side movement and in a clockwise and counterclockwise circular movement and repeating the movements down the leg at approximately 2-inch increments until the ball is positioned at the knee and then rolling the inner calf around the ball in an upward and downward movement, in a side to side movement and in a clockwise and counterclockwise circular movement until the ball reaches the ankle;
(d) the practitioner turning the person's foot in and then out and rolling the ankle around the ball in an upward and downward movement, in a side to side movement and in a clockwise and counterclockwise circular movement;
(e) the practitioner repeating steps (a), (b), (c) and (d) on the person's other leg;
f) the practitioner placing the ball under the person's pubic bone and placing the hands on the person's sacrum and rolling the pelvis around the ball in an upward and downward movement, in a side to side movement and in a clockwise and counterclockwise circular movement;
(g) the person raising their arms up above their head, the practitioner moving the ball to just above the pubic bone, placing one hand on each side of the person's pelvis and rolling the pelvis around the ball in a side to side movement and in a clockwise and counterclockwise circular movement;
(h) the practitioner positioning the ball approximately 2-inches above the bottom of the sternum above their head, the person to breathing into the ball, tractioning the arm on one side of the head with one hand whilst the other hand is placed at the side of the person's spine pushing the arm upward and rolling the person around the ball in a side to side movement and in a clockwise and counterclockwise circular movement and repeating the movements up the person's sternum at approximately 2-inch increments until the ball is positioned at the person's collarbone;
(i) the practitioner moving the arm being tractioned out to the side at shoulder level and the person turning their head in the opposite direction, positioning the ball just below the collarbone and with one hand positioned on the person's upper back at shoulder level and the other hand holding the top of the shoulder and the top of the arm, tractioning the arm in then out repeatedly, moving the arm upward and downward, moving the shoulder in large circles both clockwise and counterclockwise and repeating the movements across to the shoulder at approximately 2-inch increments until the ball is positioned at the shoulder joint.
(j) the practitioner rolling the arm around the ball down in an upward and downward movement, in a side to side movement and in a clockwise and counterclockwise circular movement and repeating the movements down the arm at approximately 2-inch increments until the ball is positioned at the wrist;
(k) the practitioner turning the arm and repeating step (j);
(l) the practitioner repeating steps (h), (i) and (j) on the person's other side
(m) the practitioner placing the ball under one of the person's hamstrings just below the sitbone with the person lying face up, tractioning the leg out from the hip, rolling the leg around the ball, in an upward and downward movement, in a side to side movement and in a clockwise and counterclockwise circular movement and repeating the movements down the leg at approximately 2-inch increments until the ball is positioned approximately 2 inches above the knee;
(n) the practitioner placing the ball under the knee, tractioning the leg from below the knee, placing one hand above the knee and one hand below the knee and applying traction in both directions for approximately 30 seconds and then rolling the knee from side to side around the ball and subsequently rolling the knee around the ball in small clockwise and counterclockwise circular movements and repeating the movements down the calf at approximately 2-inch increments until the ball is positioned at the ankle;
(o) the practitioner repeating steps (m) and (n) on the person's other leg;
(p) the practitioner bending one of the person's knees upwards and crossing that knee over the other side of the person's body, placing the ball underneath the hip and bending the knee out to the side so that the ball is at the hip joint and rolling the hip around the ball such that the ball rolls along the crease of the hip joint,
(q) the practitioner bringing the knee back from across the body, removing the ball and positioning the hip back downwards, placing the ball just at the outside of the hip, lowering the knee downwards so that the outside of the thigh lies over the ball, tractioning the leg out from the hip, rolling the leg from side to side around the ball and subsequently rolling the leg around in large clockwise and counterclockwise circular movements and repeating the movements down at approximately 2-inch increments until the ball is positioned at the ankle;
(r) the practitioner repeating steps (p) and (q) on the person's other leg;
(s) the practitioner placing the ball under the person's sacrum, standing over the person, with one leg on either side of the person's body and with one hand placed on each of the person's hips, rolling the pelvis around the ball from side to side, moving the ball to one side so that it is under the gluteus maximus muscle, rolling the pelvis from side to side around the ball and subsequently rolling the pelvis around in clockwise and counterclockwise circular movements, moving the ball to the other side so that it is under the gluteus maximus muscle, rolling the pelvis from side to side around the ball and subsequently rolling the pelvis around in clockwise and counterclockwise circular movements;
(t) the practitioner moving the ball to the person's lower back, just above the pelvic bone, on one side of the lumbar spine, holding the abdomen on that side with one hand whilst holding the person's back at a point just above the ball and tractioning slightly upward with the other hand, rolling the person's body around the ball in an upward and downward movement, in a side to side movement and in a clockwise and counterclockwise circular movement;
(u) the person raising the arm associated with the side of the body upon which step (q) was conducted above their head, the practitioner moving the ball up the rib cage and with one hand rolling the rib cage around the ball in an upward and downward movement and in a side to side movement whilst lifting the person's shoulder with the other hand and repeating the movements at approximately 2-inch increments until the ball is positioned at the level of the collarbone;
(v) the practitioner supporting the person's head and neck with one hand whilst the other hand is positioned on the person's shoulder and upper chest, stretching the person's upper rib Cage out and around the ball, wrapping the shoulder down and around the ball, moving the ball out to towards the shoulder joint and repeating wrapping the shoulder down and around the ball at approximately 2-inch increments;
(w) the practitioner repeating steps (t), (u) and (v) on the person's other side;
(x) the practitioner placing the ball under the back of the person's neck on one side, tractioning the shoulder on that side downward with one hand, placing the other hand on the person's occipital ridge and lifting upward on that side of the head, rolling the person's head and shoulder from side to side around the ball whilst maintaining traction to increase the length of the neck;
(y) the practitioner repeating step (x) on the person's other side.
